(19) United States
(12) Patent Application Publication
(10) Pub. No.: US 2021/0133684 A1
(43) Pub. Date: May 6, 2021

(54) INTELLIGENT PROCESS AND FRAMEWORK FOR DOMESTIC WORKER AND EMPLOYER REGISTRATION; VERIFICATION OF CRIMINAL BACKGROUND, WORK HISTORY AND FEEDBACK; PROVIDING A PLATFORM FOR BUILDING A COMMUNITY AND MATCHING OF SERVICES; AND A MEANS OF PROVIDING FINANCIAL SERVICES TO BOTH

(71) Applicant: Ahmedyar Janjua, Toronto (CA)

(72) Inventor: Ahmedyar Janjua, Toronto (CA)

(21) Appl. No.: 16/675,429

(22) Filed: Nov. 6, 2019

(51) Int. Cl. G06Q 10/10; G06Q 40/00; G06Q 40/06; G06Q 20/36; G06Q 10/06

(52) U.S. Cl. CPC G06Q 10/1053; G06Q 40/125; G06Q 40/06; G06Q 50/265; G06Q 20/3672; G06Q 10/06398; G06Q 20/363

(57) ABSTRACT

A method of bringing into the forefront domestic workers, part of the undocumented workforce, by providing a platform (system) to the employers to register domestic workers as employees or an opportunity to the domestic workers themselves to self-register as workers (available to work), and by providing opportunity to the employers to verify the work history as well as criminal background of these workers/employees before or during their employment. This system will accept the employer/employee data through a means of government issued citizenship number (social security number or equivalent), using that information, the database will check their previously listed work history, and provide that to the potential employer, as a means of reference/verification. The employer/employee will be given the opportunity to buy insurance for themselves and their entire families. Donors will also be given the opportunity to buy insurance products for (and on behalf of) employees/workers. Based on the employee/worker information and ratings, and specific job requirements, platform (system) will create a match for the employer to choose the best possible employee. Similar system will be available to the worker to choose a job as per his requirements and specifications. Both will have interfaces to send and receive financial payments, through “mobile wallet”, and keep an official record of the monetary exchanges. Micro finance facilities will be given on social/credit rating based on algorithm designed around feedback and work ethic of worker. Time management and salary calculations for workers will be communicated to the employers. This will be encompassed by a preference based online community, separately for both employers and employees, to discuss various issues regarding their workplace issues or problems.

### BACKGROUND OF THE INVENTION

### 1. Field of the Invention

The present invention generally relates to designing a system to help workers build up a life from poverty to self-sufficiency. This is specifically applicable to the developing world where a large number of these workers exist (Asia, Africa & South America) below the poverty line. This system will give the opportunity to these workers to gain economic independence while protecting themselves legally, by being able to register their working hours, calculating their salaries, and by availing themselves of the best employment opportunities. These, and the provision of insurance and finance products, are amongst the numerous features in this system designed for their social uplift.

### 2. Description of the Prior Art

Great number of studies show relationship between crime and its determinants. The results of these studies show that the major factor for promoting crime throughout the world is rising poverty, income and wage inequality, unemployment, illiteracy and other socio-economic factors. Especially in the developing countries and third world, domestic workers have increasingly become part of this phenomenon (poverty & crime). Risks involved in hiring workers encompass unprecedented security hazards. These workers can be privy to very valuable private information of their employers, which may be used for committing criminal activities such as robbery, burglary, harassment, kidnapping or blackmail etc.

The embodiments of the presented process render a way through which these workers will be screened (before or during hiring), and their work history will be recorded through this platform. Their background criminal history may also be checked through various law enforcement agencies.

The aim of this process is to create a verifiable work history of the workers apart from keeping track of their criminal record, thus rewarding the honest, hardworking workers by building a social safety net for these workers with the availability and easy access to micro-insurance, microfinancing, micro-savings and other financial opportunities. The platform will enable donors (both private and public) to specifically help “workers/employees” and their families to bridge a way from poverty to self-sufficiency. The highlights of the process include the following:
Registration: capture the worker's photograph and the image of his/her citizenship/identification card, once due consent has been taken.
Verification: transmit (and receive) the relevant captured information to a government verification agency.
Providing feedback: both the employer and worker provide feedback into the system with regards to the engagement.
Matching services: employment & career management, with the ability to look for a job as per the worker's & employer's specifications and preferences including but not limited to workhours, overtime pay, vacation etc.
Financial management: send and receive monetary compensation for the services provided or consumed, additionally using the money for personal or workers financial needs in different available products and services (including banking & insurance).
Building an online community: interact with people online based on various needs, e.g. a community of workers/employers, etc.
Education & Training: coaching and making people aware of different rules, laws and other important relevant information.

### SUMMARY OF THE INVENTION

The invention aims to address an issue which is faced by domestic workers in a number of developing countries, mostly from Far East Asia, South Asia, Africa, as well as South America, where domestic workers exist in poverty. These countries are characterized by significantly large undocumented economies, and a weak writ of government for enforcement of labor laws. Domestic workers on one end work in less than favorable conditions, and on the other, are sometimes stigmatized (due to general perception created by the actions of a few criminal elements) as being involved either directly or indirectly in a significant number of criminal activities against their employers (such as theft, robberies, kidnapping as well as murders).

Economic theory talks about the need to provide the following to bring the Domestic Workers from poverty to self-sufficiency:
Family Stability
Well-being
Education & Training
Financial Management, including ability to meet emergent expenditures (including healthcare)
Employment & Career Management

To achieve the above, this invention will bring the following stakeholders on one platform by leveraging technology:
Domestic workers & Blue-Collar Laborers;
Employers;
Multilateral agencies such as the International Labor Organization (ILO);
Government agencies;
Specialized non-governmental organizations (NGO);
Financial Institutions;
For-Profit organizations;

The invention uses a unique single unified framework based on a system that includes registration of individuals, their verification (citizenship & background criminal check), and provision of feedback once the engagement/job has ended. Along with this, automated help with employment & career management is also provided. This will be based on their skill set and other variables, along with complete and simplified financial management and insurance related tools, as well as providing and building an online community for professionals with the end goal of educating and training the workers, which would help alleviate them from the vicious cycle of exploitation and poverty.
Registration: involves capturing the workers photograph, and the image of their citizenship/identification card.
Verification is transmitting the relevant captured information to a government law enforcement agency for necessary criminal background check.
Providing feedback involves both the employer and worker providing feedback to each other into the system with regards to the completed job or assignment.
Matching services involves employment & career management. Having the ability to look for a job as per the worker's & employer's specification and then matching the requirements. Working hours/overtime/holiday management tools etc.
Financial management involves sending and receiving monetary amount for the services provided or consumed, additionally, using the money for personal or employers/workers financial needs in different available products and services. These include providing various insurance options (such as hospital coverage, accidental, etc.), an essential component of an ideal working environment, as well as providing micro-loans to service emergency needs of the employers/workers, along with using the system to avail educational funds.
Building an online community involves employers/workers interacting with each other online based on various needs, e.g. a community of workers/employers, etc., which is there to service/support/offer help on difficult matters. These will be demarcated based around the role of the person, be they an employer or a worker.
Education & Training involves coaching and making people aware of different rules, laws, and other important relevant information to help them look after their basic human rights and protect them from exploitation. Visual and video tools will be provided, based on need.

### BRIEF DESCRIPTION OF THE DRAWINGS

FIG. 1: The flowchart illustrates our unique method for the registration of the employers & domestic Workers.

FIG. 2: The flowchart illustrates in greater detail, the process of registration of households and domestic workers

FIG. 3: The flowchart that illustrates the OPTIONAL VERIFICATION process of the domestic workers which can be done, as we move laterally on FIG. 1

FIG. 4: The flowchart is a continuation of processes as depicted in FIG. 1 and illustrates the part where evaluation of the worker will be done through feedback of different stakeholders.

FIG. 5: The flow chart illustrates a continuation of the processes as depicted in FIG. 1, where job locating/matching will be done.

FIG. 6: The flowchart illustrates the process where information collected earlier, will be shared with stakeholders as a form of feedback and “information sharing”.

FIG. 7: The flowchart illustrates how the information sharing in FIG. 6 will be charged a certain fees for the services provided.

FIG. 8: The flowchart that illustrates a continuation of the process described in FIG. 7, where monetary compensation would come in, and services of micro-finance/micro-savings would be offered.

FIG. 9: The flowchart that illustrates how micro-finance/micro-savings services as described in FIG. 8, along with insurance services, would be offered. These would be offered in conjunction with, and help of, different stakeholders, and would offer separate forums of communication with their peers.

FIG. 10: This mind map illustrates the Employer's Dashboard, which encompasses all the above figures and gives an overview as to how the Employer will interact with various situations. This includes functionalities which will become essential for their organization & management of affairs, and the unique way that this will happen.

FIG. 11: This mind map illustrates the Worker's Dashboard, which encompasses all the above figures and gives an overview as to how the worker will interact with different stakeholders as well as the services available to them from this platform. This includes functionalities which will become essential for their organization & management of affairs, and the unique way that this will happen.

FIG. 12: This mind map illustrates the Service Provider's Dashboard, which encompasses all the above figures and gives an overview as to how the service provider will interact with various situations. This includes functionalities which will become essential for their organization & management of affairs, and the unique way that this will happen.

FIG. 13: This mind map illustrates the Donor's Dashboard, which encompasses all the above figures and gives an overview as to how the donor will interact with various situations. This includes functionalities which will become essential for their organization & management of affairs, and the unique way that this will happen.

### DETAILED DESCRIPTION OF THE EMBODIMENT

Based on the difficulty faced by various organizations in trying to penetrate this part of the labor sector, it will be appreciated what this invention intends to achieve, and the uniqueness with which this is being done is explained through the following descriptions, claims, and drawings, in which:

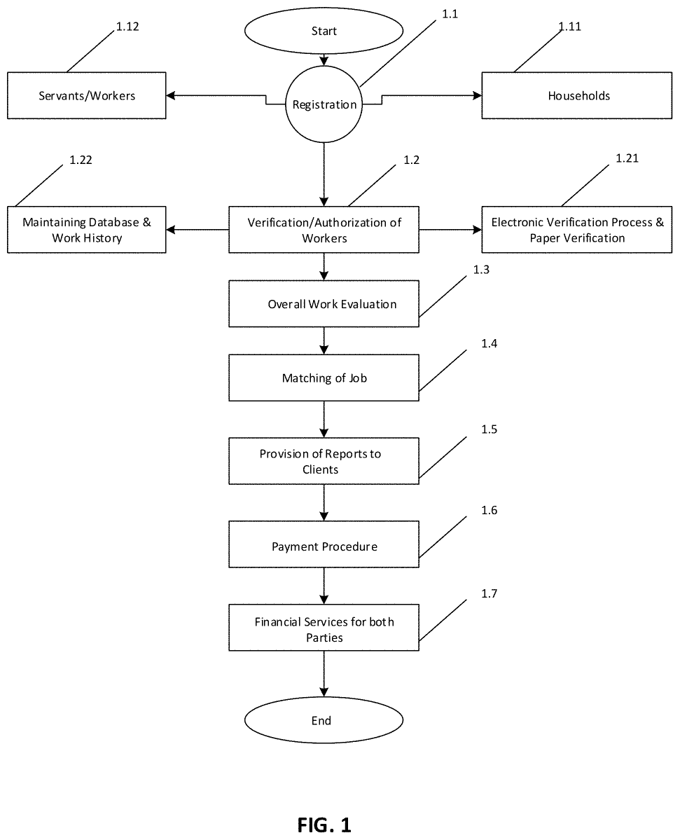

FIG. 1: illustrates a hierarchical structure of the process which extends to show each part of the process;

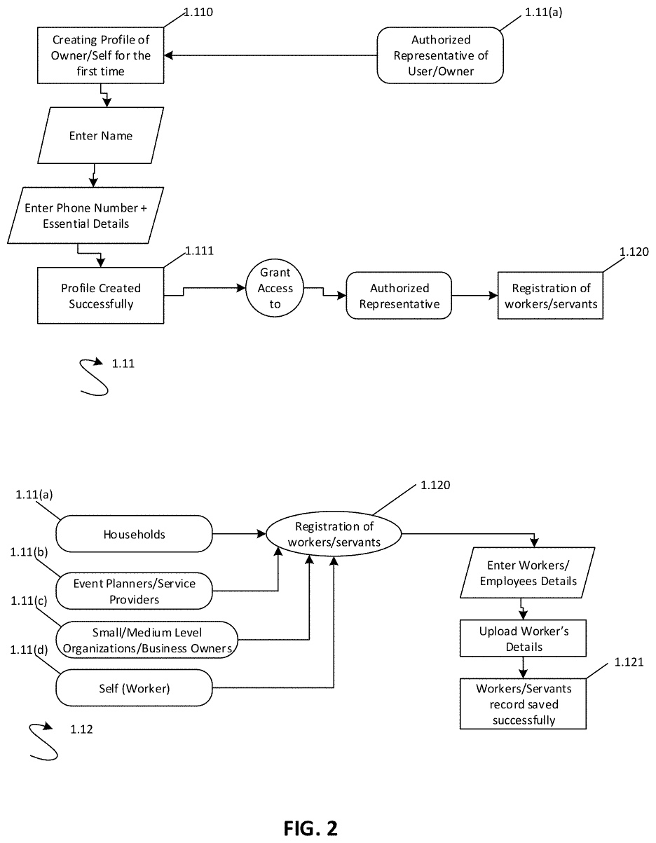

FIG. 2: shows the registration process: Subsection 1.11 shows the profile creation of households (employers); Subsection 1.12 shows the registration of domestic workers/staff (workers) by the households (employers);

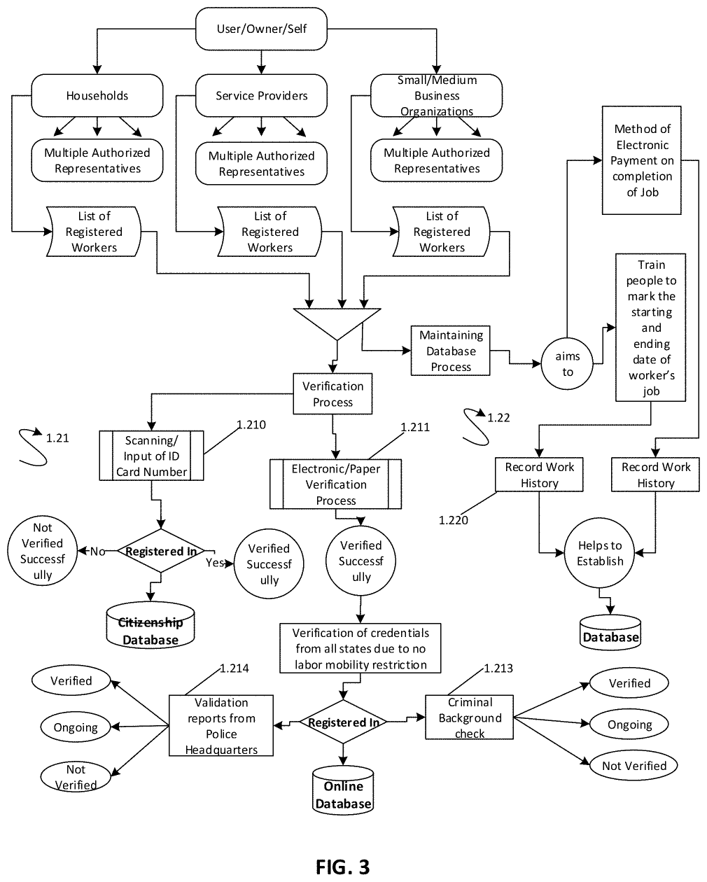

FIG. 3: shows the OPTIONAL VERIFICATION and authorization of workers: Subsection 1.21 shows the verification of workers through their Government issued ID numbers and law enforcement agencies. In the same view, 1.22 refers to maintenance of a database which includes both 1.220 and 1.221; 1.220 illustrates the process for recording the work history monitoring worker from their joining date till termination of their services, 1.221 shows the recording of credit history by assessing the earning ability of a worker;

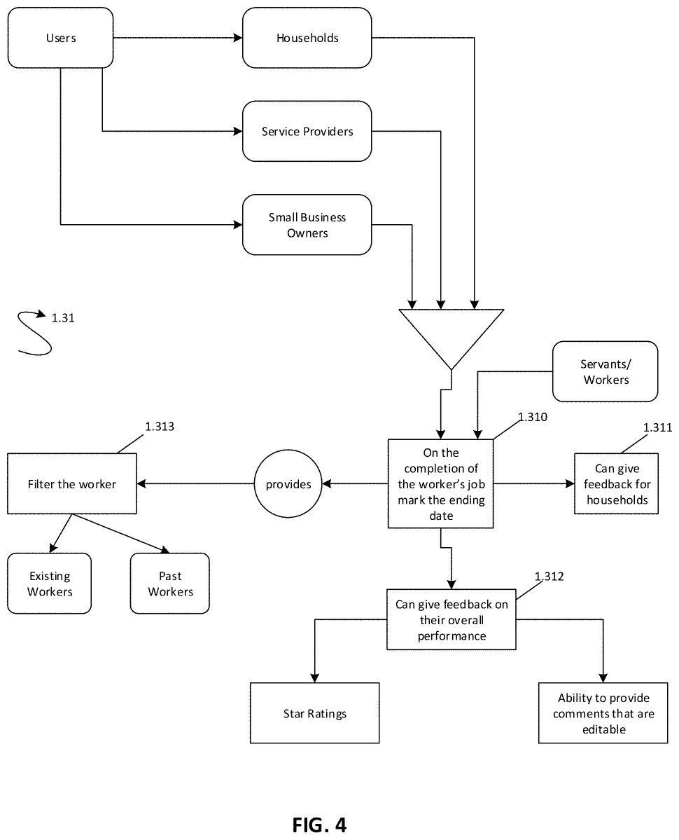

FIG. 4: shows the evaluation of overall services of workers provided by the employers: 1.311 shows that workers shall also be able to give feedback to employers; 1.312 illustrates that employers will be able to give feedback on workers performance;

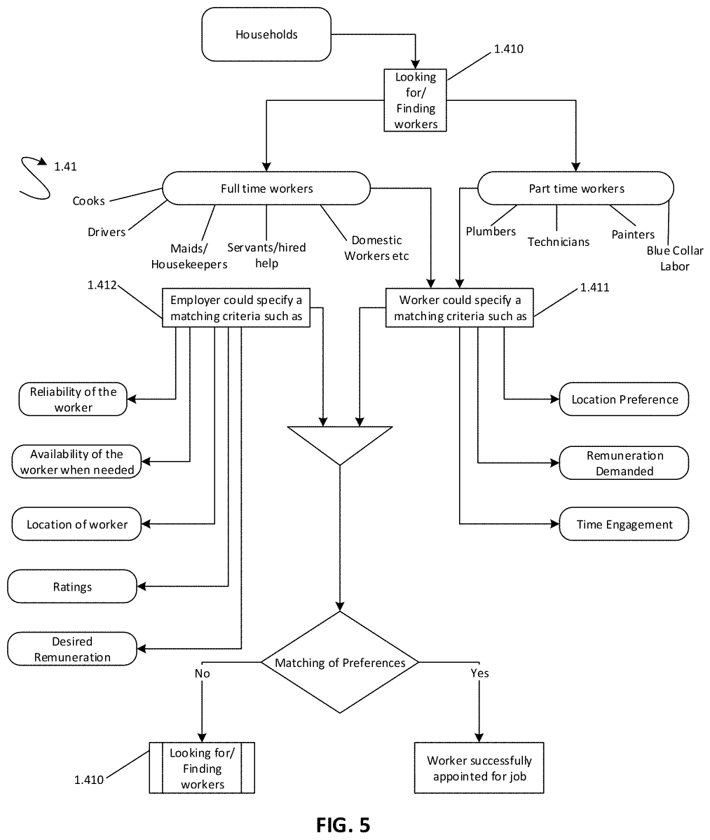

FIG. 5: illustrates the matching of services view based on variable preferences of both employers and the workers: 1.412 shows the preferences of employers such as location of workers, availability of workers, the amount of money they will be charging, level of averaged star ratings etc before hiring a worker that could be a part time or full time worker; adjacent to it 1.411 shows the number of preferences of workers before accepting a job which may include location of employer, amount of salary, time engagement etc.;

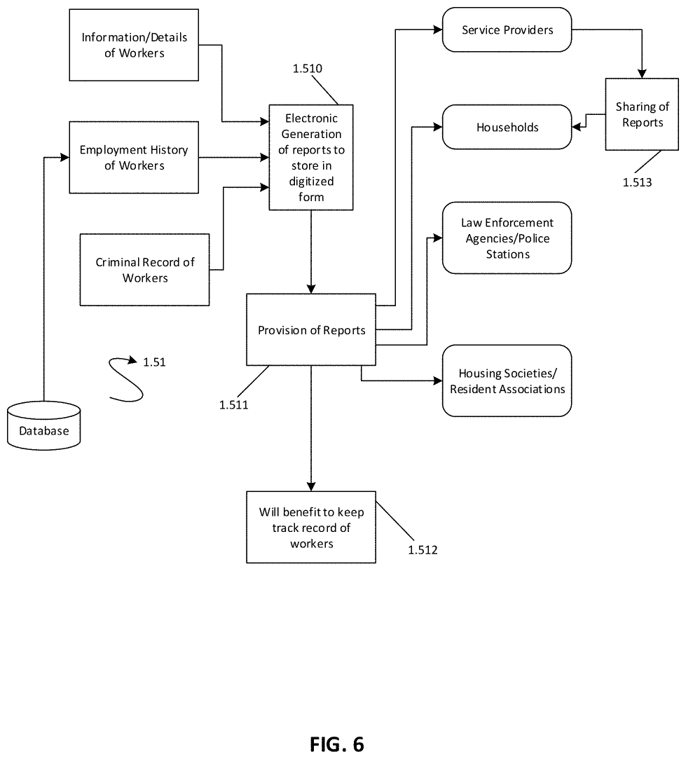

FIG. 6: illustrating the generation of electronic reports and their provision to clients: 1.511 shows these clients will be service providers, employers, law enforcement agencies, housing societies, resident associations; 1.513 shows the sharing mechanism of these reports by service providers to employers via electronic channel; 1.512 further shows how a pragmatic approach will be held through transmission of these reports;

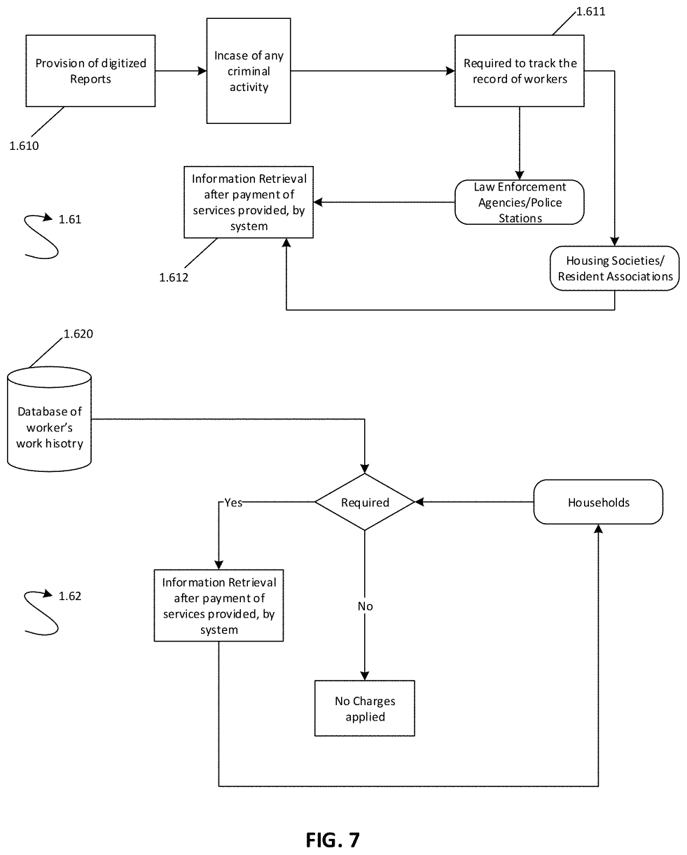

FIG. 7: shows the payment process for the provision of digitized reports to clients followed by the maintenance and provision of the worker's working history to clients in 1.61 and 1.62 respectively. 1.612 shows that the charged amount is flexible depending upon the economic conditions.

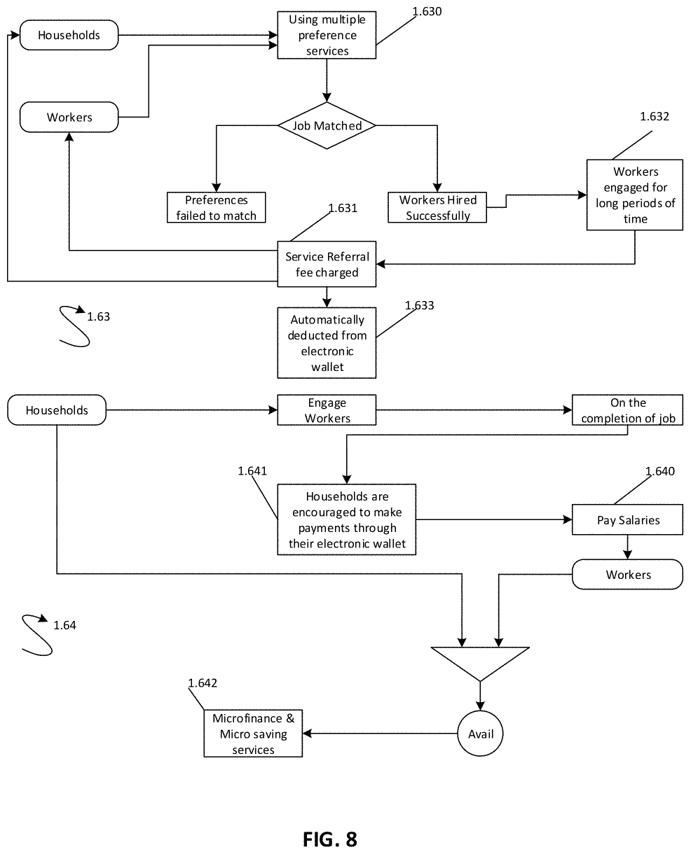

FIG. 8: is bisected in 1.63 and 1.64 illustrating the payment process for using multiple preference services and the payment to be made after the completion of job respectively. 1.630 shows that the multiple preference services could be used by both the employers and the workers for the service/referral fee mentioned on board shows 1.631. Further, 1.633 shows the automatic deduction from employer's mobile/electronic wallet that will be linked to household's bank accounts. 1.632 shows that the charged fee depends on the time duration of workers engaged in a particular job. In 1.64, 1.642 shows that both the employers and the workers could avail financial services such as microfinance, microinsurance and microsaving services, etc.

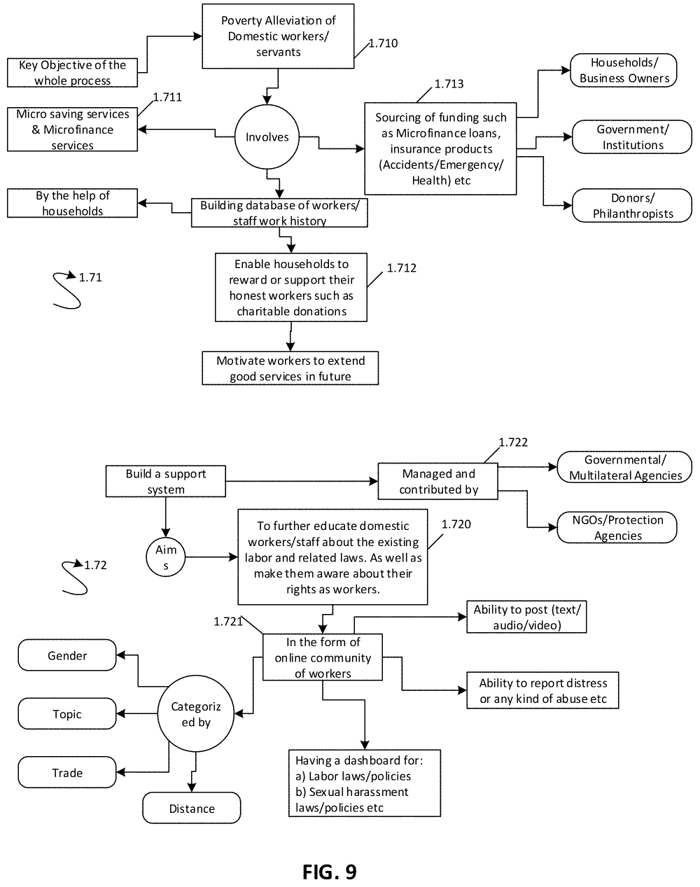

FIG. 9: illustrates the basic aim and objective of the whole process in two parts as 1.71 and 1.72. In which 1.710 shows how the whole process aids to alleviate poverty among the workers. 1.712 shows that the employers are able to support their workers by any means, they could also reward their workers and their families through donations and funds etc., whereas 1.713 shows different sources for funding that can be microfinance loans and insurance products etc., by employers, Government/Institutions and Donors/Philanthropists. 1.72 shows that a supports system is provided to the domestic workers/staff by spreading awareness among them about the existing labour laws and policies as shown in 1.720. Whereas 1.721 illustrates that an online community is formed for these workers categorized according to their preferences, also having a dashboard available to them for education and training about different issues and topics such as labor policies, sexual harassment policies, etc. Workers can post their issues on this forum by several means. They can also report about any distress or abuse. 1.722 illustrates that this community is managed and contributed by government/multilateral as well as NGOs/protection agencies.

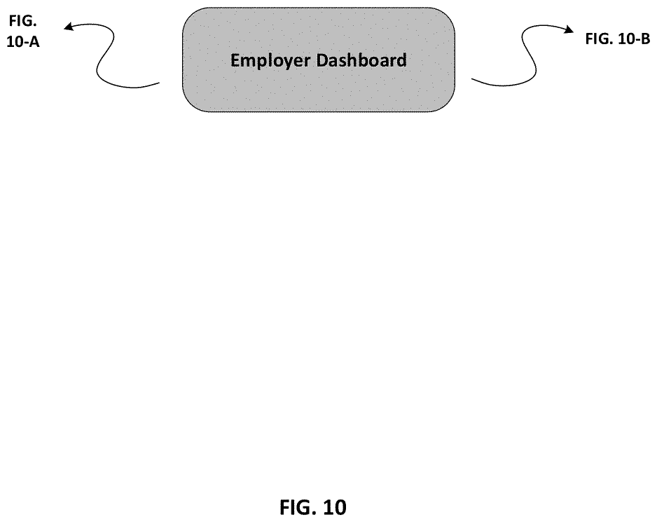

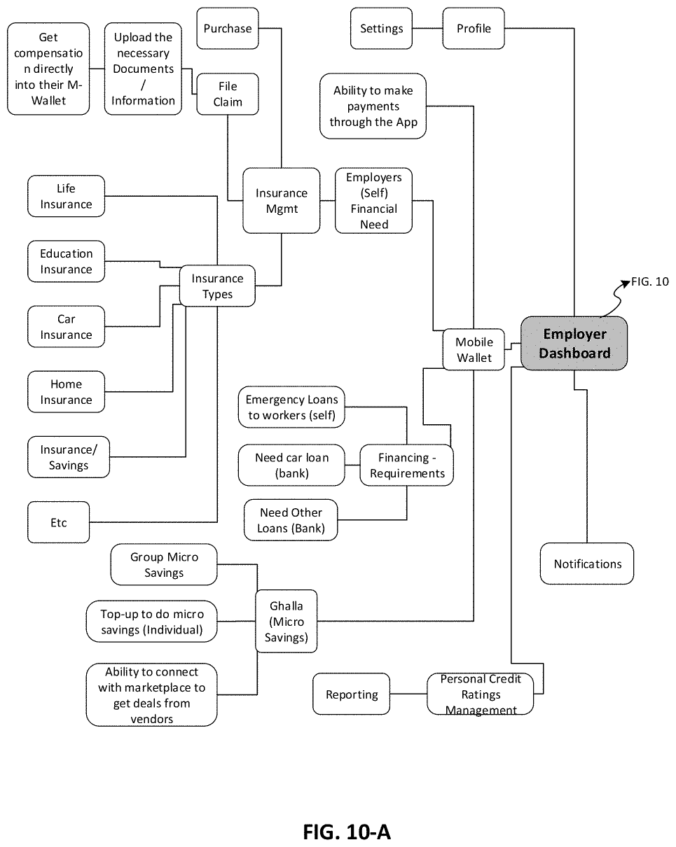

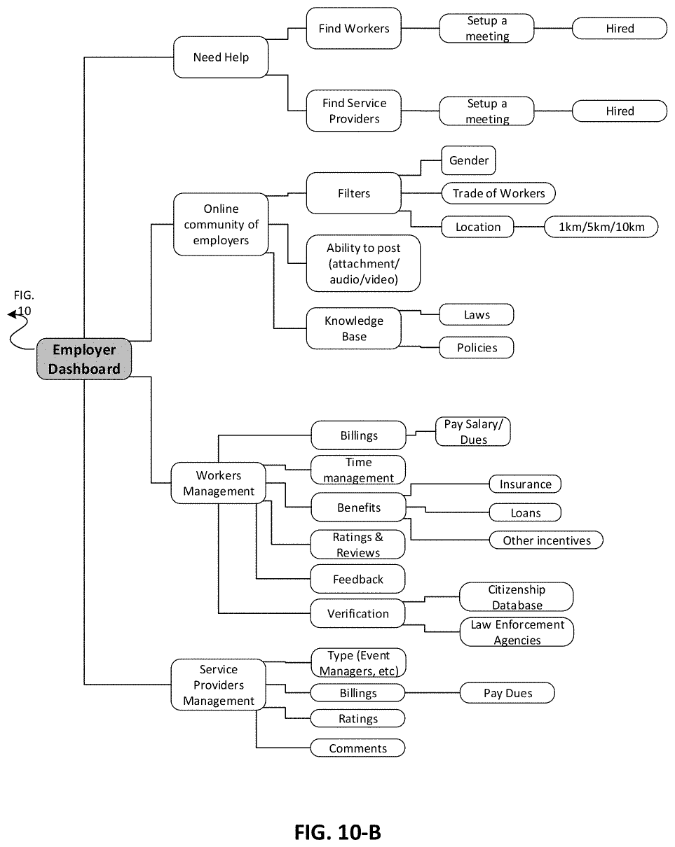

FIG. 10 is a mind map that illustrates the Employer's Dashboard, that will have multiple (eight in the illustration) connections to the dashboard of the employer. This overview is how the system will be designed to facilitate for the utility of the employer, where he/she will be managing different sections under him/her. These include the i) help section, ii) online community of employers, iii) management of workers under his/her employment, iv) tab of service providers whom the employer will be using from time to time example being event managers, v) a notifications tab to give him/her updates to any changes, vi) employer's own credit rating management, vii) a mobile wallet, and lastly viii) his/her profile management section.

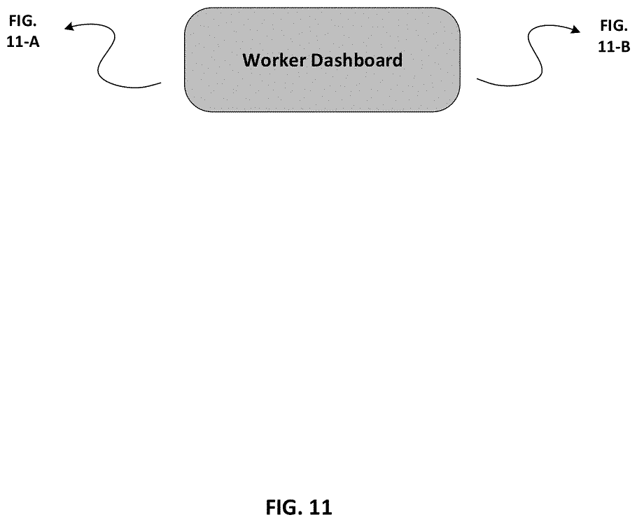

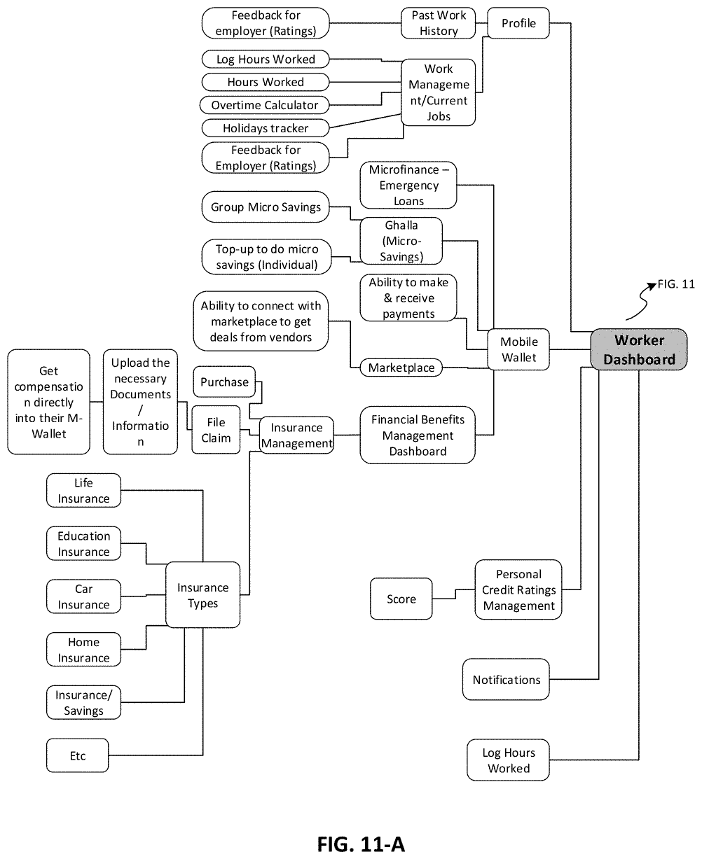

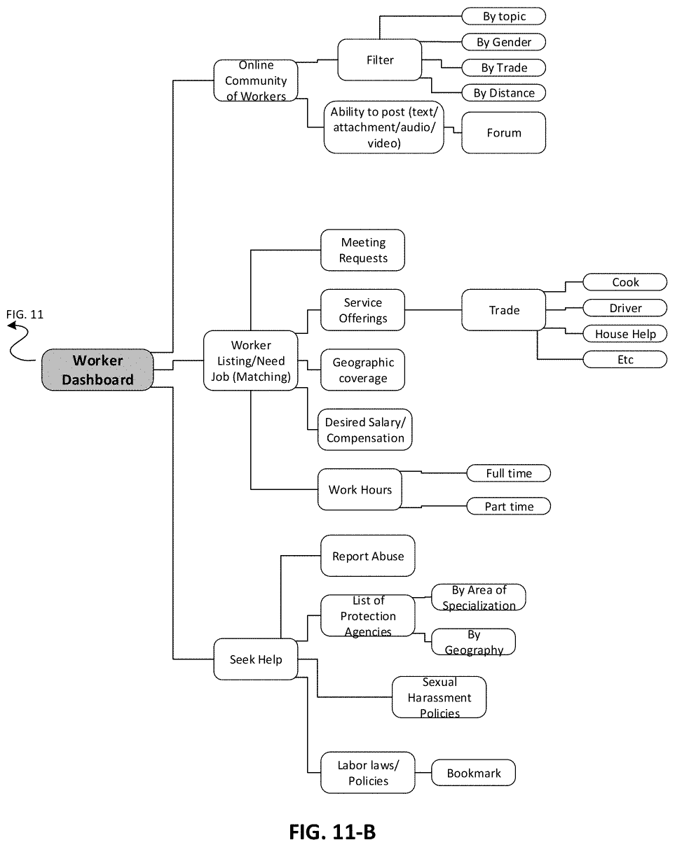

FIG. 11 is a mind map that illustrates the Worker's Dashboard, that will have multiple (eight in the illustration) connections to the dashboard of the worker. This overview is how the system will be designed to facilitate for the utility of the worker, where the worker will be managing different areas. These include the i) assistance section, ii) online community of workers, iii) listing of matching jobs that the worker could be seeking, or his/her own advertisement of the job that he/she needs will be listed on this tab, iv) log of hours that he/she has worked at his/her present employer to keep a tab on the future payments that he/she is to receive based on this information, this information will be communicated to his/her employer as well, v) a notifications tab to give him/her updates to any changes, vi) worker's own credit rating management, vii) a mobile wallet, and lastly viii) his/her profile management section.

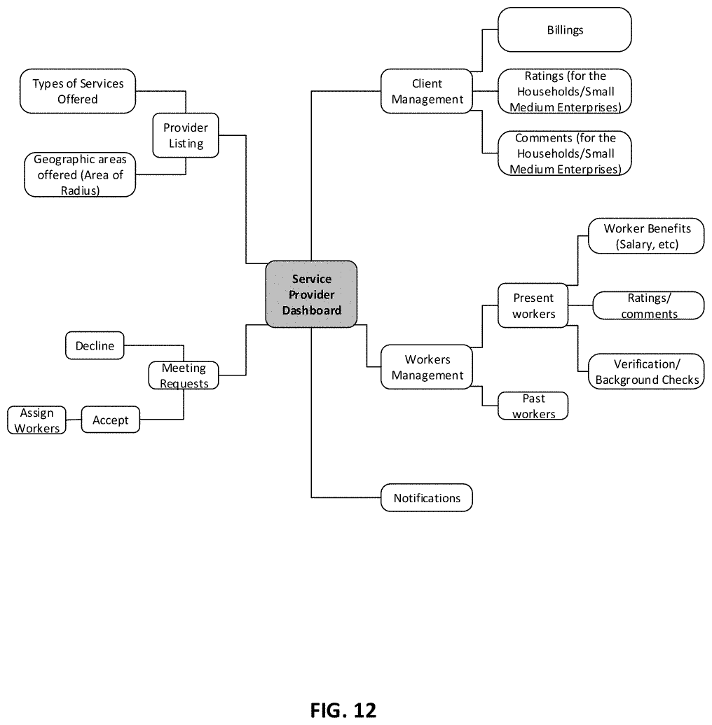

FIG. 12 is a mind map that illustrates the Service Provider's Dashboard, that will have multiple (five in the illustration) connections to the dashboard of the service provider. As mentioned in FIG. 10 (iv) above, this will be connected to the dashboard of the employer, and the Service Provider's Dashboard will have connections based on how he/she will service the potential employer. These will include the i) Client Management Board (households & businesses) that he/she will be servicing and these he/she will be managing through this dashboard that will be available to him/her, ii) worker's management tab which he/she will be using to keep a log of employees those who are working for him/her, iii) a notifications tab to give him/her updates to any changes, iv) a meeting requests tab to keep him/her abreast with upcoming appointments with present and potential clients that have contacted him/her through this app, v) a provider listing tab to let him/her post the services which he/she can provide potential employers comprising of the workers he/she has available with him/her.

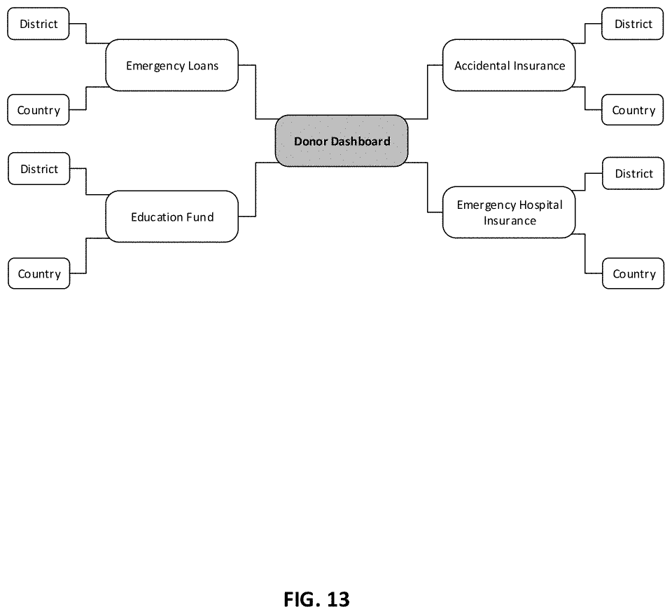

FIG. 13 is a mind map that illustrates the Donor's Dashboard, that will have multiple (four in the illustration) connections to the dashboard of the donor. This will be the interface available to the Donor who wants to donate money to the various options (type of financial assistance/geography) available to him/her, where he/she can help the domestic workers. This will be provided so that donations can play a significant part in alleviating the workers from poverty. The interfaces available to the donors would be i) the ability to provide funding to workers for their accidental insurance, ii) the ability to provide funding to workers for their emergency hospital insurance, iii) the ability to provide funding to workers for their children's education fund, iv) the ability to provide funding to workers for any emergency loans that they might require.

1. A handheld computer implemented method to register domestic workers as employees, not through traditional means of paper registration, but paperless. Scanning identity documents through this App (software application), and getting these (identity documents) verified through law enforcement agencies of the region. Further from this, criminal history of these workers will be checked, and information will be gathered from their previous employers as a form of feedback. Once hired, payment would be dispensed to these workers by the employers through a “mobile wallet”, so that a track record of transactions and employment be kept. Once employment ends, a feedback will be obtained from the employer and employee, to be placed on their corresponding histories, so that this will be used for future job matching purposes as well as access to other financial services. Records will be kept of the history of this whole interaction/transaction, and based on this a social/credit rating will be built to further the process of providing various financial services products such as microfinance, microsaving and insurance facilities for the employers/workers. Amongst different users of this system, online communities will be developed for educational and training purposes. This will help safeguarding rights, and minimize abuse.

2. A method as described in claim 1, and as shown in FIG. 2, an extension of the registration process, the employer (in this case a ‘household’ member) will create a profile for themselves in order to register an employee, essentially creating a profile under his/her name. This will have the employer's essential details. He/she will then allow other representatives to use this database, essentially appointing managers allowing them to employ people on their behalf, and allowing the database to grow under their name.

3. A method as described in claim 1, and as shown in FIG. 2, an extension of the registration process, the ‘employee’ will get their registration done from various sources (for example households, event planners, service providers and small to medium level businesses), or will have the option to enter their own personal information to register themselves, and essentially allow the database to be built in their own name. This information will, in the future, be incorporated under the details of an employer under whom they seek employment. This will further allow the employee the option of rating the employer, and give the employee the option of seeking any future employment under the area of his/her own expertise, allowing seamless future job matching.

4. A method as described in claim 1, and as shown in FIG. 3, is an extension of the registration process, coming under the bracket of verification of the employees. The employers (for example households, event planners, service providers, small to medium level businesses, etc.) will have a list of employees listed under their profile in the database. An optional process will be followed to either get them verified through local law enforcement agencies, based on the government issued identification documents used to register the employees initially, or simply maintain them in the database under the profile of the employer, and as a part of the entire database. Verification would encompass the checking of past criminal record. This verification process, as shown in FIG. 3, will be recorded in the database as a future reference. Once the information of the employee has been entered in the main database, under the database of the employer, the term of the employee will start, and until that term is ended, a history of payments, as well as other financial benefits provided to the employee will be kept in the database. Feedbacks will also be exchanged at the end of the employment term. This will help maintain the database, and more importantly help build the social/credit history of the employee. Algorithms will be derived to dispense micro-saving loans, micro finance and other financial services from this collected information.

5. A method as described in claim 1, and as shown in FIG. 4, covers the evaluation & calculation method of the system. Once a job is completed, the employer, as well as the employee, both will provide and have access to give each other feedback, while having the ability to update their respective systems and mark the end of the work period. The feedback will be in the form to capture the employees' on-job performance such as “star ratings” and comments (based on individual preferences, which would be editable).

6. A method as described in claim 1, and as shown in FIG. 5, encompasses the job matching feature of the system. Once an employer decides on hiring help, the employer will decide whether it is part time, or full-time employees that he/she needs. Various options will be presented to the employer based on their preferences. These could be such as location preferences, salary provisions of the job, the amount of time needed for the engagement, etc. At the same time needs/requirements from the employee would be needed to create a ‘match’. Factors which would play a role in the matching process would include, but not limited to, the reliability of the worker (based on previous references, feedback, etc), time availability of the worker, location preferences of the worker, as well as the salary demanded. The algorithm designed will create a ‘match’ for both the employer and employee, keeping all the variables in front.

7. A method as described in claim 1, and as shown in FIG. 6, this section deals with provision of reports to clients, essentially, information sharing. This section basically deals with making an informed decision. The database being maintained by the system would, upon request of the future employer, and consent of the employee, be shared with the client, be they service providers/households/law enforcement agencies/housing societies, based on their need/requirement. The algorithm designed would provide a portal for all these requirements, and would be able to tap into the database of the system.

8. A method as described in claim 1, and as shown in FIG. 7, a fee will be charged for the services provided in claim 7. This will be based around the information sought from different employers (be the law enforcement agencies, housing societies, businesses, household, etc) that would be looking to employ an individual. If the information of that individual is in the system, and if the information is sought, a fee will be charged when sharing it, but only after due consent of the employee.

9. A method as described in claim 1, and as shown in FIG. 8, continuing with the payment system while providing the services of job matching. When the potential employer initiates a search of potential employees, keeping different parameters in mind, results in a match, and subsequent to which that worker is ‘matched’ with the job, a referral fees/payment will be charged. The services charges from the employer/employee will will be automatically deducted from the “mobile wallet” or through any other method as preferred by the users of the platform. This wallet will be used, as mentioned in claim 1, for dispensing moneys owed to the employee. This wallet would be present for both the employee and the employer, as a financial interface. The employee/employer can use this wallet for availing various financial services being offered such as microfinance/micro savings purposes, as these will be dispensed based on factors earlier mentioned in claim 1, ie work history/work-ethics/credit history/credit rating etc. An algorithm will be designed specifically for evaluating the employees to potentially avail the credit and financial services facilities. The availability of this credit as well as other financial services to the employers/employees would serve as an incentive to maintain an excellent work history as the feedback received from the employer/employee will serve as a major factor for dispensing these loans from the system.

10. A method as described in claim 1, and as shown in FIG. 9, is a continuation of claim 9, and is centered on various poverty alleviation initiatives. These will include giving access to facilities such as micro-finance, micro-savings and insurance to employers/employees, which can be purchased for them by employers/government institutions/donors or philanthropists. To avail these facilities, a “work history” would need to be maintained, based around the algorithm built to factor in feedbacks received, honesty, and consistency of work ethic of the employee, resulting in building a social/credit history, around which these loans can be dispensed. Furthermore, a support system will be built around work opportunities, education, training and community support.

11. Employer's Dashboard: The FIG. 10 as shown, reflects how a unique system will be designed as an interface for the employer. The functionality and the interface which will be shown to the Employer, will show various connections, e.g. mobile wallet, personal credit ratings management, notifications, service provider management, workers management, online community of employers or help, etc. A unique interface/system will be designed to manage the entire working of the system, especially related to the organization of the employer.

12. Workers Dashboard: FIG. 11 as shown, reflects how a unique system will be designed as an interface for the employee. The functionality and the interface which will be shown to the Employee, will show various connections, e.g. profile, mobile wallet, personal credit ratings reports, notifications, help, log hours worked, worker listing, need job (matching), online community of workers etc. A unique interface/system will be designed to manage the entire working of the system, especially related to the organization of the employee.

13. Service Provider Dashboard: The FIG. 12 as shown, reflects how a unique system will be designed as an interface for the service provider. The functionality and the interface which will be shown to the service provider, will show various connections, e.g. meeting requests, provider listing, notifications, workers management, client management (households as well as business owners), etc. A unique interface/system will be designed to manage the relationship management process between the service providers and the households as well as businesses.

14. Donors Dashboard: FIG. 13 as shown, reflects how a unique system will be designed as an interface for the donor. The functionality and the interface which will be shown to the donor, will show various connections, e.g. education fund/emergency loans/emergency hospital insurance/accidental insurance, etc. A unique interface/system will be designed to manage the entire working of the system, especially related to the organization of the donor.
